(19) United States
(12) Patent Application Publication
(10) Pub. No.: US 2005/0013289 A1
(43) Pub. Date: Jan. 20, 2005

(54) IP communication device

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 10/867,807

(22) Filed: Jun. 16, 2004

(30) Foreign Application Priority Data
Jul. 14, 2003 (JP) 2003-196354

(51) Int. Cl. H04L 12/66

(52) U.S. Cl. 370/352

(57) ABSTRACT

An IP communication device which, when carrying out a new IP communication with a destination that is already carrying out an IP communication, can simplify a communication operation and improve the speed of a communication process and also reduce the time and effort required until starting the new communication. When accepting a starting request for starting the new IP communication with a destination that is carrying out the IP communication, an IP address of the destination that is carrying out the IP communication stored in a destination IP address stored unit is designated as a communication destination. Then, the new IP communication is executed on the connection that is carrying out the IP communication.

### BACKGROUND OF THE INVENTION

1. Field of the Invention

The present invention relates to an Internet Protocol (IP) communication device which uses an IP network as a data transmission path and transmits various communication data such as voice data, image data and text data.

2. Description of the Related Art

In a conventional G3 facsimile machine having a telephone set for a telephone conversation, when carrying out a facsimile transmission manually, first, a telephone call is made to another party and a telephone conversation is held with the other party. Then, a start key is pressed to switch to the facsimile transmission. The voice telephone conversation and the facsimile communication cannot be carried out in parallel with one another.

To solve such a problem, there is a communication device which can simultaneously establish a plurality of communication connections by using communication by the Internet Protocol (IP) (hereinafter referred to as the “IP communication”), specifically, an IP telephone communication and an IP facsimile communication based on the International Telecommunication Union-Telecommunications (ITU-T) Recommendation T.38, and carry out the IP facsimile communication and the voice telephone conversation in parallel with one another.

The conventional communication device can carry out the IP facsimile communication and the telephone conversation by the IP telephone in parallel with one another. Meanwhile, while an IP communication is being carried out, to start another IP communication, an operator is required to input destination information (an IP telephone number, a Uniform Resource Locator (URL), etc.) of the destination again. Moreover, the communication device presents the input destination information to a Domain Name System (DNS) server, and executes a process for acquiring an IP address. Therefore, a long period of time is required until a connection has been established with the destination after the operator instructs to start a new communication.

### SUMMARY OF THE INVENTION

The present invention has been made in view of the above-described circumstance. An advantage of the present invention is to provide an IP communication device which, when carrying out new IP communication with a destination that is already carrying out IP communication, can simplify a communication operation and improve the speed of a communication process and also reduce time and effort required until starting the new communication.

According to an aspect of the present invention, an IP communication device includes a communication unit, an accepting unit and an establishing unit. The communication unit carries out communication with another IP communication device via a network. The accepting unit accepts a starting request for starting a new IP communication with the other IP communication device while the IP communication is being carried out with the other IP communication device. When the accepting unit accepts the starting request, the establishing unit establishes a new IP communication by multiplexing at an upper layer of the network by using a connection that is carrying out the IP communication.

According to another aspect of the present invention, the IP communication device includes a communication unit, a storage unit, an accepting unit and an establishing unit. The communication unit carries out communication with another IP communication device via a network. The storage unit stores connection information with the other IP communication device. The accepting unit accepts a starting request for starting a new IP communication with the other IP communication device while the IP communication is being carried out with the other IP communication device. When the accepting unit accepts the starting request, by using the stored connection information, the establishing unit establishes a new connection that is different from a connection that is carrying out the IP communication. Then, the establishing unit establishes a new IP communication.

A type of the communication of the IP communication that is being carried out is voice communication. A type of the new IP communication is data communication.

A type of the communication of the IP communication that is being carried out is data communication. A type of the new IP communication is voice communication.

The starting request for starting the new IP communication is carried out by a communication starting operation that does not specify a communication destination. The communication starting operation differs from a communication starting operation carried out when communication is not being carried out.

The new IP communication is processed in advance, in preference to the IP communication that is being carried out.

According to the present invention, a process for inquiring a server or the like as to an IP address is omitted, and a period of time required from an instruction to start a new communication until a start of the new communication can be shortened. In addition, an operation for starting a new communication while another communication is being carried out can be simplified.

Since a telephone conversation with the destination and a transmission of data of an original document can be carried out in parallel with one another, favorable communication can be carried out.

### BRIEF DESCRIPTION OF THE DRAWINGS

FIG. 1 is a block diagram showing an example of a configuration of a communication device and an example of a configuration of a network in which the communication device is provided according to an embodiment of the present invention.

FIG. 2 is a functional block diagram for the communication device to carry out a plurality of IP communications according to an embodiment of the present invention.

FIG. 3 shows an example of a table formed in a memory such as a RAM.

FIG. 4 is a sequence diagram showing a communication protocol established between communication devices when data is transmitted from a communication device of a transmitter (calling side) during a telephone conversation between the communication devices according to a first embodiment of the present invention.

FIG. 5 is a sequence diagram showing a communication protocol established between communications devices when an IP telephone call is made from the communication device of the transmitter to a communication device of a destination while data communication is being carried out between the communication devices according to the first embodiment of the present invention.

FIG. 6 is a sequence diagram showing a communication protocol established between communication devices when another data is further transmitted while data is being transmitted between the communication devices according to the first embodiment of the present invention.

FIG. 7 is a sequence diagram showing a communication protocol established between communication devices when data is transmitted from a communication device of a transmitter (calling side) while a telephone conversation is being carried out between the communication devices according to a second embodiment of the present invention.

FIG. 8 is a sequence diagram showing a communication protocol established between communication devices when an IP telephone call is made from the communication device of the transmitter to the communication device of a destination while data communication is being carried out between the communication devices according to the second embodiment of the present invention.

### DETAILED DESCRIPTION OF THE PREFERRED EMBODIMENTS

### First Embodiment

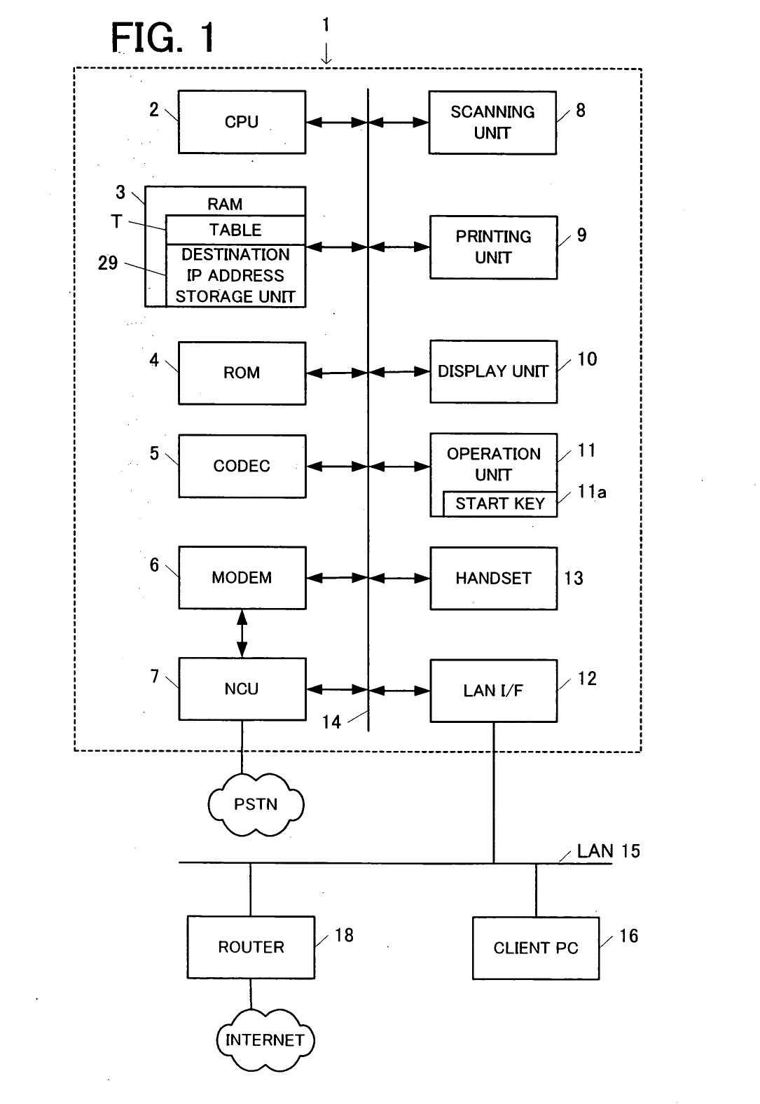

Referring to the drawings, as an example of an IP communication device according to a first embodiment of the present invention, a multifunction peripheral typed communication device having an IP communication function and a G3 facsimile communication function or the like will be described. FIG. 1 shows an example of a configuration of a communication device 1.

The communication device 1 includes a Central Processing Unit (CPU) 2, a Random Access Memory (RAM) 3, a Read Only Memory (ROM) 4, a codec 5, a modem 6, a Network Control Unit (NCU) 7, a scanning unit 8, a printing unit 9, a display unit 10, an operation unit 11, a Local Area Network (LAN) interface 12 and a handset 13. Each of the units 2 through 13 is connected via a bus 14 in a manner capable of carrying out communication.

The CPU 2 controls each of the units of the communication device 1 in accordance with a program stored in the ROM 4.

The RAM 3 functions as a storage unit that stores image data, various pieces of setting information, a destination IP address to be described later, a table T or the like.

The ROM 4 stores various programs for controlling an operation of each of the units of the communication device 1 by the CPU 2.

The codec 5 encodes image data for transmission in accordance with Modified Huffman (MH), Modified Read (MR) or Modified Modified Read (MMR) method or the like, and decodes received image data. The codec 5 also encodes and decodes according to a Tagged Image File Format (TIFF), which is an image format generally used as a file format of an attached file of electronic mail.

The modem 6 modulates and demodulates transmitted and received data in accordance with the ITU-T Recommendations V.34 standard or anything similar to this.

The NCU 7 connects and disconnects a telephone call by controlling a telephone line. The NCU 7 is connected to a Public Switched Telephone Network (PSTN).

The scanning unit 8 scans image data of an original document and outputs image data converted in binary of black and white.

The printing unit 9 adopts an electro-photographic method or the like and prints received image data or the link onto a recording paper.

For example, the display unit 10 is formed of a Liquid Crystal Display (LCD) or the like provided in proximity to the operation unit 11. The display unit 10 displays various pieces of screen information.

The operation unit 11 includes input keys for inputting various pieces of information such as a telephone number and a mail address, and a start key 11a for carrying out a transmission starting instruction, or the like. The operator carries out various operations from the operation unit 11.

The LAN interface 12 is an interface for establishing a connection between a LAN 15 and the communication device 1 so that communication can be carried out. A client Personal Computer (PC) 16 is provided on the LAN 15. The client PC 16 can use the various functions of the communication device 1. Moreover, a router 18 is provided on the LAN 15. The communication device 1 can carry out IP communication with another IP communication device (not shown) through the router 18, the Internet or the like.

The handset 13 is formed of a receiver or the like for the operator to have a telephone conversation by an IP telephone or by a telephone via the PSTN.

The above-described communication device 1 includes a voice communication function by the IP telephone and a data communication function by the IP facsimile communication function. The communication device 1 also includes a function for simultaneously carrying out one or a plurality of voice communication and data communication with the same destination by the IP communication. Further, in this specification, the “voice communication” is not included in the “data communication”.

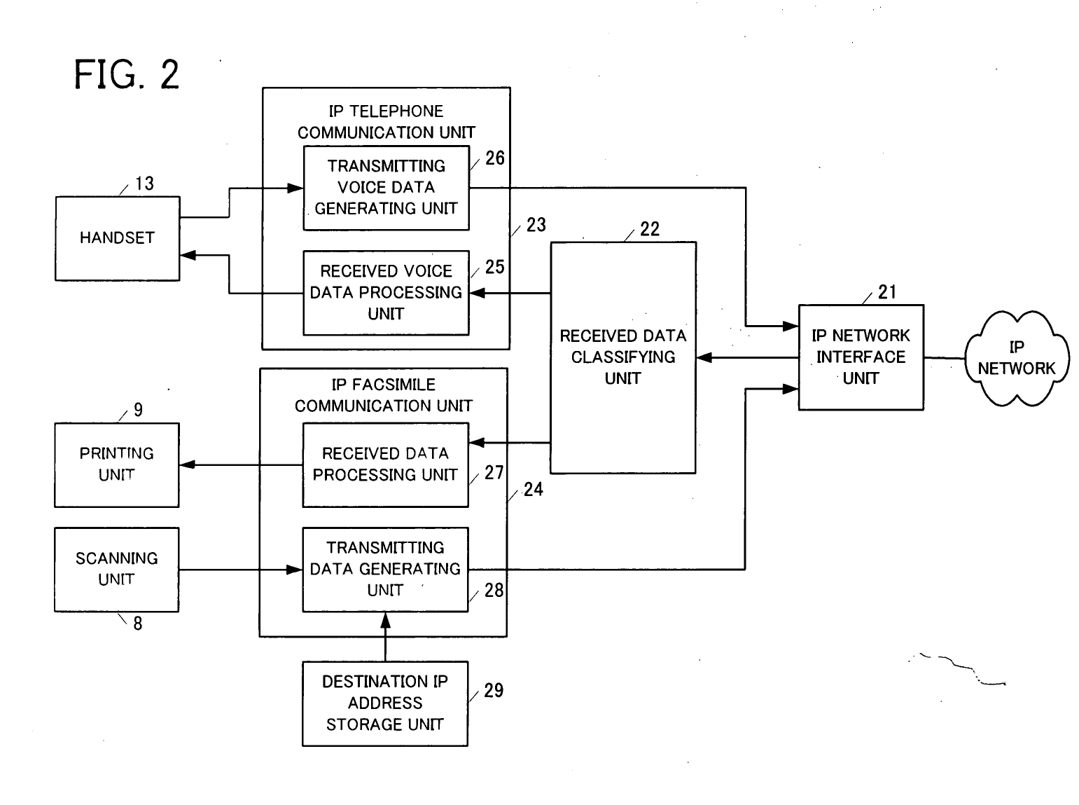

FIG. 2 shows functional blocks formed on the above-described hardware configuration by the communication device 1. That is, the communication device 1 can carry out one or a plurality of voice communication and data communication simultaneously with the destination through an IP network by an IP network interface unit 21, a received data classifying unit 22, an IP telephone communication unit 23 and an IP facsimile communication unit 24.

The IP network interface unit 21 is an interface with the IP network, in other words, the Internet or an intranet. The IP network interface unit 21 outputs to the received data classifying unit 22, an IP packet supplied from the IP network through a communication connection.

The received data classifying unit 22 analyzes input data, and classifies and outputs data relating to the voice communication (hereinafter referred to as the “voice data”) to the IP telephone communication unit 23, and data relating to the data communication to the IP facsimile communication unit 24. Further, a determination of whether the data relates to the voice communication or the data communication is carried out in accordance with specifying information included in the received packet. The specifying information is information that indicates whether the data relates to the data communication or the voice communication. The specifying information is added to each packet by an application when the communication device 1 carries out IP transmission. Therefore, the received data classifying unit 22 can classify and output the data only for the communication carried out between the communication devices 1.

The IP telephone communication unit 23 consists of a received voice data processing unit 25 and a transmitting voice data generating unit 26. The received voice data processing unit 25 analyzes the voice data input from the received data classifying unit 22 and executes a decoding process or the like. Then, the received voice data processing unit 25 outputs analog voice data to a speaker of the handset 13. The transmitting voice data generating unit 26 encodes and packetizes the analog data of speaking voice of the operator input from a microphone of the handset 13. In addition, the transmitting voice data generating unit 26 adds the specifying information or the like to the analog data and outputs the data to the IP network interface unit 21. Further, in the output of the data from the transmitting voice data generating unit 26, a prevention for a delay in the transmission of the voice data is carried out in preference to a lack of the data.

The IP facsimile communication unit 24 includes a received data processing unit 27 and a transmitting data generating unit 28. The received data processing unit 27 analyzes the received data input from the received data classifying unit 22 and executes a decoding process or the like. Then, the received data processing unit 27 outputs the received data to the printing unit 9 (in case of distributing, to the client PC 16 or the like that is a distribution destination). The transmitting data generating unit 28 encodes and packetizes the data scanned by the scanning unit 8 or the data input from the client PC 16, and adds the specifying information or the like to the data. In addition, the transmitting data generating unit 28 outputs the data to the IP network interface unit 21 with the IP address stored in a destination IP address storage unit 29 as a communication destination. Further, the output of the data from the transmitting data generating unit 28 differs from the transmitting voice data generating unit 26, and a quality of the data is carried out in preference to a prevention of a delay in the transmission.

In the communication device 1 that constitutes the above-described functional blocks, during the voice communication or the data communication, when receiving a starting request for starting new data communication or voice communication with the same destination, the IP address of the same destination stored in the destination IP address storage unit 29 is designated, and a process for starting the voice communication or the data communication is carried out.

The communication device 1 is registered with information relating to a presence or an absence of the voice communication function or the data communication function of the destination in advance by the operator or the like. When there is an instruction to carry out new data communication or voice communication with the same destination as the destination that is carrying out the communication, a determination is made as to whether or not the new communication can be carried out in accordance with the registered information. When the new communication cannot be carried out, the new communication is not carried out.

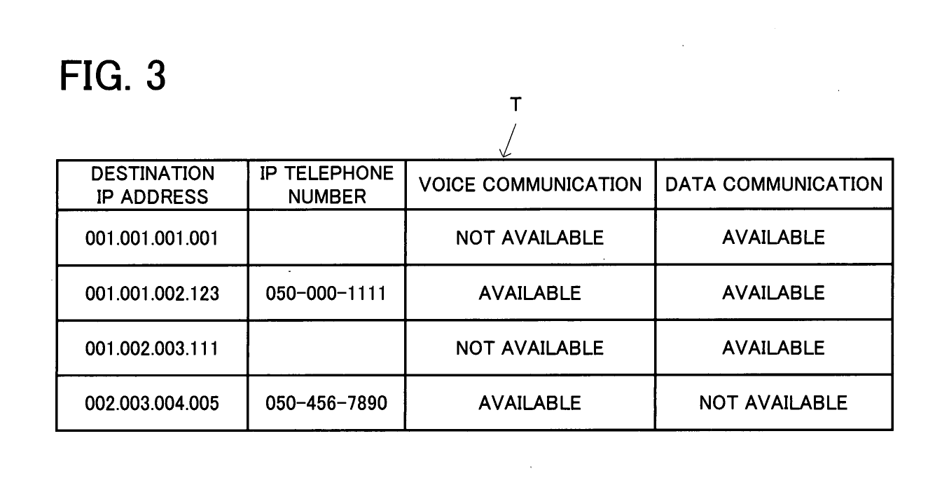

The information relating to the presence or the absence of the communication function of the destination is registered with a table T formed in the RAM 3, as shown in FIG. 3. The table T includes a “destination IP address” column, an “IP telephone number” column, a “voice communication” column and a “data communication column”. The information in each column is associated with one another by being stored in the same record. In the “destination IP address” column, the IP address of the destination is registered. In the “IP telephone number” column, the IP telephone number of the destination is registered. In the “voice communication” column, a determination of whether the communication device of the destination has the voice communication function is registered. When the voice communication can be carried out, “AVAILABLE” is registered. When the voice communication cannot be carried out, “NOT AVAILABLE” is registered. In the “data communication” column, a determination of whether the communication device of the destination has the data communication function (in the present embodiment, the IP facsimile communication function) is registered. When the data communication can be carried out, “AVAILABLE” is registered. When the data communication cannot be carried out, “NOT AVAILABLE” is registered.

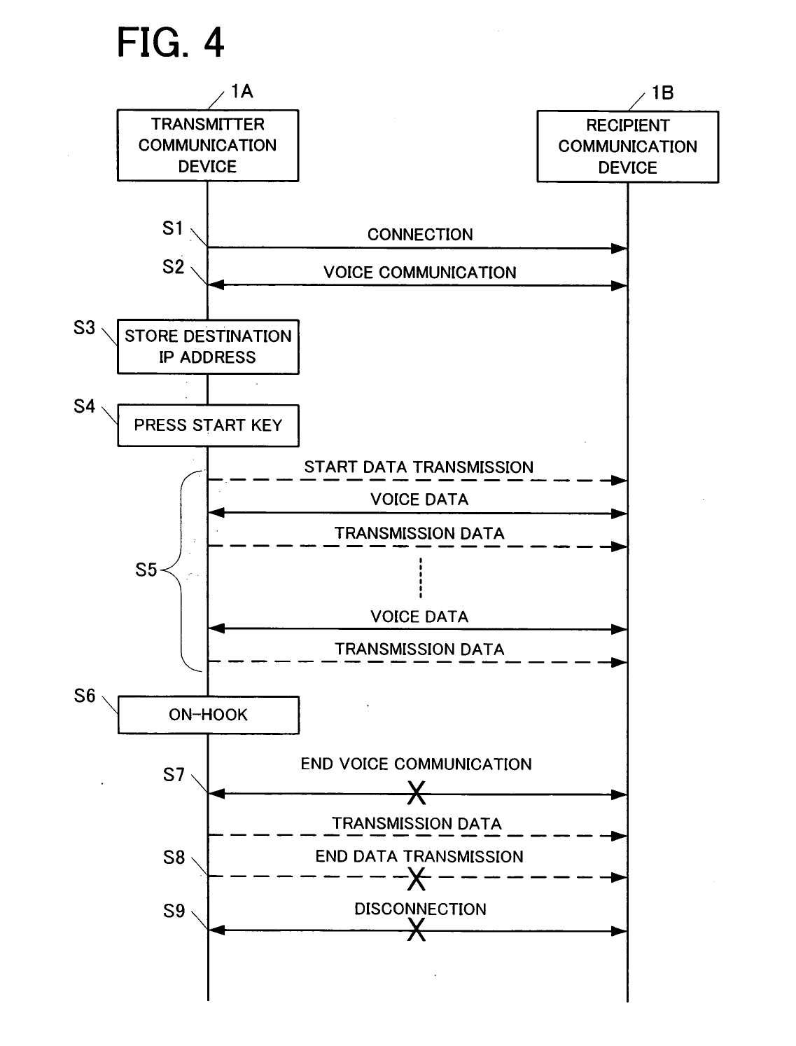

Referring to the sequence diagram of FIG. 4, a description will be made to a communication protocol established between the communication devices 1 and 1 when transmitting data from the communication device 1 of the transmitter (calling side) while a telephone conversation is being held between the communication devices 1 having the above-described configuration and the communication functions. Further, for a convenience of the description, the communication device 1 of the transmitter will be referred to as a transmitter communication device 1A and the communication device 1 of the recipient will be referred to as a recipient communication device 1B.

When an operator of one of the communication devices (transmitter communication device) 1A dials an IP telephone number of the destination (recipient communication device) 1B, a connection is established with the destination by a call control (S1). The voice communication is established between the communication devices 1A and 1B (S2). Then, the transmitter communication device 1A stores (memorizes) in the destination IP address storage unit 29, an IP address of the destination acquired from a Session Initiation Protocol (SIP) server or the like by the call control. In addition, if an IP address is already stored, the transmitter communication device 1A deletes the already stored IP address (S3).

During the voice communication, when an original document is set at the scanning unit 8 by the operator and the transmitter communication device 1A accepts a starting request for starting a new data communication by a specific communication starting operation (S4), the transmitter communication device 1A assumes that the destination that is carrying out the voice communication and a destination of the original document to be transmitted newly are the same. Here, the specific communication starting operation is an operation in which the start key 11a is pressed without the destination information (an IP telephone number, a mail address, etc.) of the destination being designated. The specific communication starting operation differs from a communication starting operation carried out when communication is not being carried out (in other words, differs from the operation in which the start key 11a is pressed after the destination information has been input). Then, in accordance with the table T, a determination is made as to whether or not the destination that is currently carrying out the voice communication can carry out the data communication (not shown). When the data communication can be carried out, image data of the original document is scanned and transmission data is generated. Then, the IP address stored in the destination IP address storage unit 29 is designated as a new transmission destination (communication destination). By using the same connection as the voice communication, the image data of the original document is transmitted. At this time, the voice communication with the destination is carried out in parallel with the data communication (S5). Since the data communication and the voice communication are carried out in parallel with one another on the same connection (one connection), by multiplexing at an upper layer (application layer) of the network, a new IP communication is established. Further, the destination is determined to be capable of carrying out the data communication when the IP address or the IP telephone number of the destination device that is carrying out the communication is registered in the “destination IP address” column and the “IP telephone number” column of the table T, and when “AVAILABLE” is registered in the “data communication” column. Accordingly, a generation of a communication error, which results from attempting data communication even though it is evident in advance that the destination does not have the data communication function, can be prevented in advance.

When the telephone conversation with the destination has been ended and the handset 13 has been on-hooked (S6), the generation and the output of the voice data from the transmitting voice data generating unit 26 of the IP telephone communication unit 23 are stopped and the voice communication ends (S7). Next, when image data of a last page of the original document is transmitted to the destination, the data transmission also ends (S8) and the established connection is disconnected (S9). Further, although not shown in the drawing, after the data communication has been ended, when the handset 13 is off-hooked, processes of ending the data communication, ending the voice communication and disconnecting the connection are executed in this order.

As described above, according to the communication device 1, the data of the original document can be transmitted while having a telephone conversation with the destination. Moreover, just by pressing the start key 11a during the telephone conversation, the destination that is carrying out the telephone conversation is designated automatically as the transmission destination of the data of the original document. Therefore, an operation for newly inputting the telephone number or the like of the destination can be omitted. Moreover, for the destination information of the destination that is carrying out the telephone conversation (transmission destination of the data of the original document), the IP address stored in the destination IP address storage unit 29 is used. Therefore, a process for inquiring the SIP server or the like as to the IP address is omitted. In addition, a period of time from the pressing of the start key 11a until the starting of the transmission of the data of the original document can be shortened.

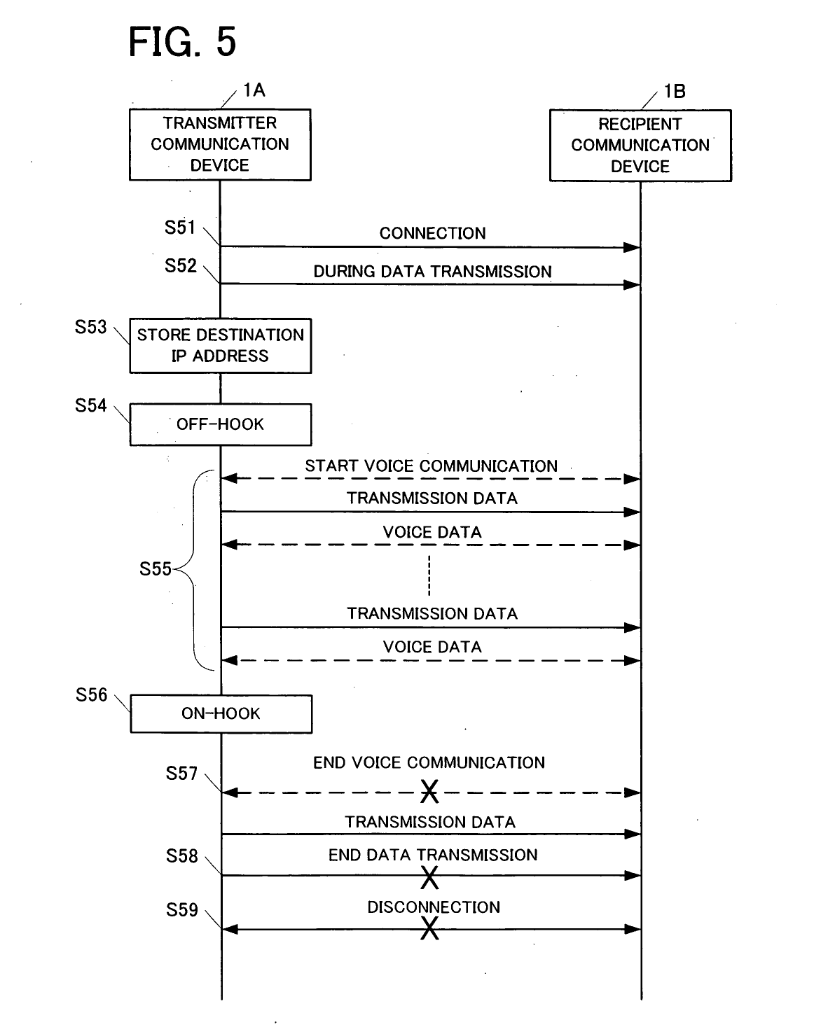

Next, referring to the sequence diagram of FIG. 5, a description will be made to a communication protocol established between the communication devices 1A and 1B when originating an IP telephone call from the transmitter communication device 1A to the recipient communication device 1B while the data communication is being carried out between the communication devices 1.

In one of the communication devices (transmitter communication device) 1A, when an original document is set at the scanning unit 8 by the operator and the IP telephone number of the destination (recipient communication device) 1B is input and designated and the start key 11a is pressed, a connection is established with the destination by the call control (S51). Then, the data communication is established between the communication devices 1A and 1B (S52). The transmitter communication device 1A stores the IP address of the destination acquired from the SIP server or the like in the destination IP address storage unit 29. In addition, if an IP address is already stored, the transmitter communication device 1A deletes the already stored IP address (S53).

During the data communication, when the transmitter communication device 1A receives a starting request of a new IP telephone by a specific communication starting operation by the operator (S54), the transmitter communication device 1A assumes that the destination that is carrying out the data transmission is the same as a transmission destination to which the voice communication will be carried out newly. Here, the specific communication starting operation differs from a communication starting operation accompanying an input operation of the telephone number of the destination carried out when communication is not being carried out. That is, the specific communication starting operation does not accompany the input operation of the telephone number of the destination. Then, in accordance with the table T, a determination is made as to whether or not the destination that is currently carrying out the data communication can carry out the voice communication (not shown). When the voice communication can be carried out, the IP address stored in the destination IP address storage unit 29 is designated as the destination of the voice communication (communication destination). Then, the voice communication is carried out by using the same connection as the data communication. At this time, the data communication is carried out with the destination in parallel with the voice communication (S55). Further, the destination is determined to be capable of carrying out the voice communication when the IP address or the IP telephone number of the destination that is carrying out the communication is registered in the “destination IP address” column and the “IP telephone number” column of the table T, and when “AVAILABLE” is registered in the “voice communication” column. Accordingly, a generation of a communication error, which results from attempting voice communication even though it is evident in advance that the destination does not have the voice communication function, can be prevented in advance.

When the telephone conversation with the destination has been ended and the handset 13 has been on-hooked (S56), the generation and the output of the voice data from the transmitting voice data generating unit 26 of the IP telephone communication unit 23 are stopped and the voice communication ends (S57). Next, when image data of a last page of the original document is transmitted to the destination, the data transmission also ends (S58) and the established connection is disconnected (S59). Further, although not shown in the drawing, after the data communication has been ended, when the handset 13 is off-hooked, processes of ending the data communication, ending the voice communication and disconnecting the connection are executed in this order.

As described above, according to the communication device 1, a telephone conversation can be carried out with the destination while the data of the original document is being transmitted. Moreover, just by off-hooking the handset 13 during the data transmission, the destination that is carrying out the data communication is designated automatically as the destination of the telephone conversation. Therefore, an operation for newly inputting the telephone number or the like of the destination can be omitted. For the destination information of the destination of the telephone conversation, the IP address stored in the destination IP address storage unit 29 is used. Therefore, a process for inquiring the SIP server or the like as to the IP address is omitted. In addition, a period of time from the off-hook of the handset 13 until the starting of the telephone conversation can be shortened.

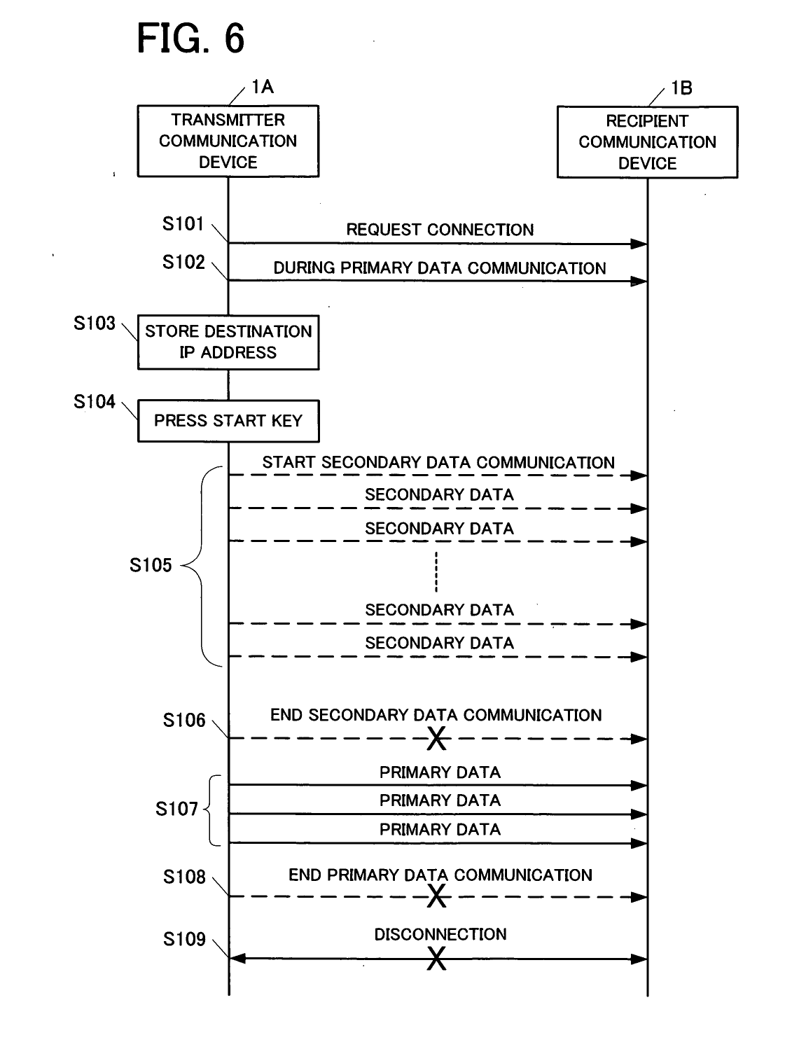

Next, referring to the sequence diagram of FIG. 6, a description will be made to a communication protocol established between the communication devices 1A and 1B when another data transmission is carried out while data transmission is being carried out between the communication devices 1.

In one of the communication devices (transmitter communication device) 1A, when an original document is set at the scanning unit 8 by the operator and the destination information (IP telephone number) of the destination (recipient communication device) 1B is input and designated and the start key 11a is pressed, a connection is established with the destination by the call control (S101). Then, the data communication (primary data communication) is established between the communication devices 1A and 1B (S102). The transmitter communication device 1A stores the IP address of the destination acquired from the SIP server or the like in the destination IP address storage unit 29, and if an IP address is already stored, the transmitter communication device 1A deletes the already stored IP address (S103).

During the data communication, when an original document is further set at the scanning unit 8 by the operator and the transmitter communication device 1A accepts a starting request for starting new data communication (secondary data communication) by a specific communication starting operation (S104), the transmitter communication device 1A assumes that the destination that is carrying out the primary data communication is the same as a transmission destination of the original document to be transmitted newly. Here, the specific communication starting operation is an operation in which the start key 11a is pressed without the destination information (IP telephone number) of the destination being designated. The specific communication starting operation differs from a communication starting operation carried out when communication is not being carried out (in other words, differs from the operation in which the start key 11a is pressed after the destination information has been input). Then, the image data of the original document is scanned, and the transmitting data is generated. The IP address stored in the destination IP address storage unit 29 is designated as the new transmission destination (communication destination). By using the same connection as the primary data communication that is being carried out, the image data of the original document is transmitted in preference to the primary data communication that is being carried out (S105). In other words, the generation and the transmission of the primary data communication, which has been started being transmitted first, are interrupted temporarily.

Then, when the secondary data communication, which has been started being transmitted later, ends (S106), the interrupted primary data communication is restarted (S107). When image data of a last page of the original document is transmitted to the destination, the data transmission also ends (S108) and the established connection is disconnected (S109).

As described above, according to the communication device 1, the secondary data can be transmitted in preference to the primary data to the same destination. Therefore, for example, according to urgency of the original document, the data can be transmitted to the destination. Moreover, just by pressing the start key 11a, the destination that is carrying out the communication is designated automatically as the transmission destination of the secondary data. Therefore, an operation for newly inputting the telephone number or the like of the destination can be omitted.

Moreover, for the destination information of the transmission destination of the secondary data (transmission destination of the data of the original document), the IP address stored in the destination IP address storage unit 29 is used. Therefore, a process for inquiring the server or the like as to the IP address can be omitted. In addition, a period of time from the pressing of the start key 11a until the starting of the transmission of the secondary data can be shortened. Furthermore, as it has been described in the description for the received data classifying unit 22, the IP telephone communication unit 23 and the IP facsimile communication unit 24, the communication device 1 carries out a multiplex of the voice communication and the data communication at the upper layer (application layer) of the network. Therefore, a plurality of communications can be carried by using the same connection, and it becomes unnecessary to establish a new call control.

### Second Embodiment

Next, a communication device 30 according to a second embodiment of the present invention will be described.

The communication device 30 includes structures and functions that are the same as those of the communication device 1 of the first embodiment. However, the communication device 30 differs from the communication device 1 in the following feature. That is, when the communication device 30 newly carries out data communication or voice communication while the voice communication or the data communication is being carried out, the communication device 30 establishes a new connection and transmits data or voice data to the destination through a different path (connection). Further, in the following, for convenience, the communication device 30 of a transmitter will be referred to as a transmitter communication device 30A and the communication device 30 of a recipient will be referred to as a recipient communication device 30B.

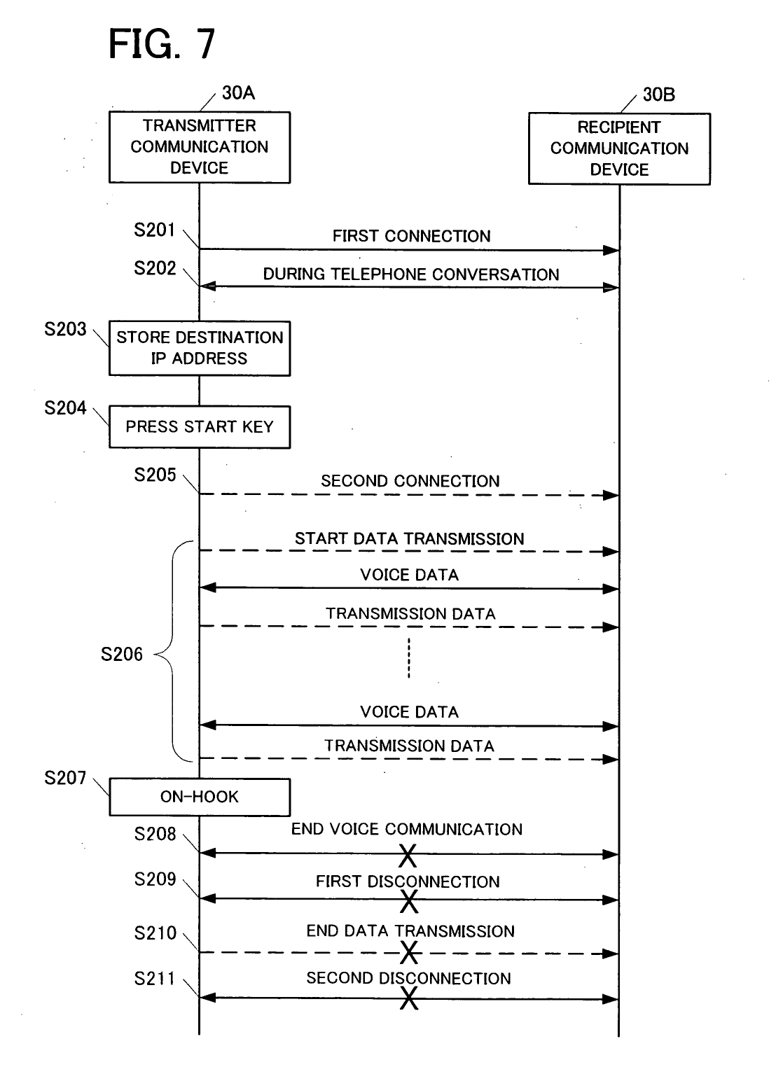

As shown in the sequence diagram of FIG. 7, in one of the communication devices (transmitter communication device) 30A, when an operator dials an IP telephone number of the destination (recipient communication device) 30B, a first connection is established with the destination by the call control (S201). Then, voice communication is established between the communication devices 30A and 30B (S202). The transmitter communication device 30A stores (memorizes) an IP address of the destination acquired from the SIP server or the like in the destination IP address storage unit 29. In addition, if an IP address is already stored, the transmitter communication device 30A deletes the stored IP address (S203).

During the voice communication, when an original document is set at the scanning unit 8 by the operator and the transmitter communication device 30A accepts a starting request for starting new data communication by a specific communication starting operation (S204), the transmitter communication device 30A assumes that the destination that is carrying out the voice communication is the same as a transmission destination of the data to be transmitted newly. Here, the specific communication starting operation is an operation in which the start key 11a is pressed without the destination information (an IP telephone number) of the destination being designated. The specific communication starting operation differs from a communication starting operation carried out when communication is not being carried out (in other words, differs from the operation in which the start key 11a is pressed after the destination information has been input). Then, in accordance with the table T, a determination is made as to whether or not the destination that is currently carrying out the voice communication can carry out the data communication (not shown). When the data communication can be carried out, by using connection information relating to the first connection that is carrying out the IP communication, in other words, by designating an IP address of the destination of the first connection stored in the destination IP address storage unit 29 as the communication destination, a second connection is established with the same destination by the call control (S205). Further, as it is evident from the above description, the second connection is a new connection that is different from the first connection.

Then, at the same time as when the voice communication is carried on the first connection, the data is transmitted from the transmitter communication device 30A to the recipient communication device 30B on the second connection (S206).

When the telephone conversation with the destination has been completed and the handset 13 has been on-hooked (S207), the generation and the output of the voice data from the transmitting voice data generating unit 26 of the IP telephone communication unit 23 are stopped and the voice communication ends (S208). Then, the first connection is disconnected (S209). When image data of a last page of the original document is transmitted to the destination, the data transmission also ends (S210) and the established second connection is disconnected (S211). Further, although not shown in the drawing, after the data communication has been ended, when the handset 13 is off-hooked, processes of ending the data transmission, disconnecting the second connection, ending the voice communication and disconnecting the first connection are executed in this order.

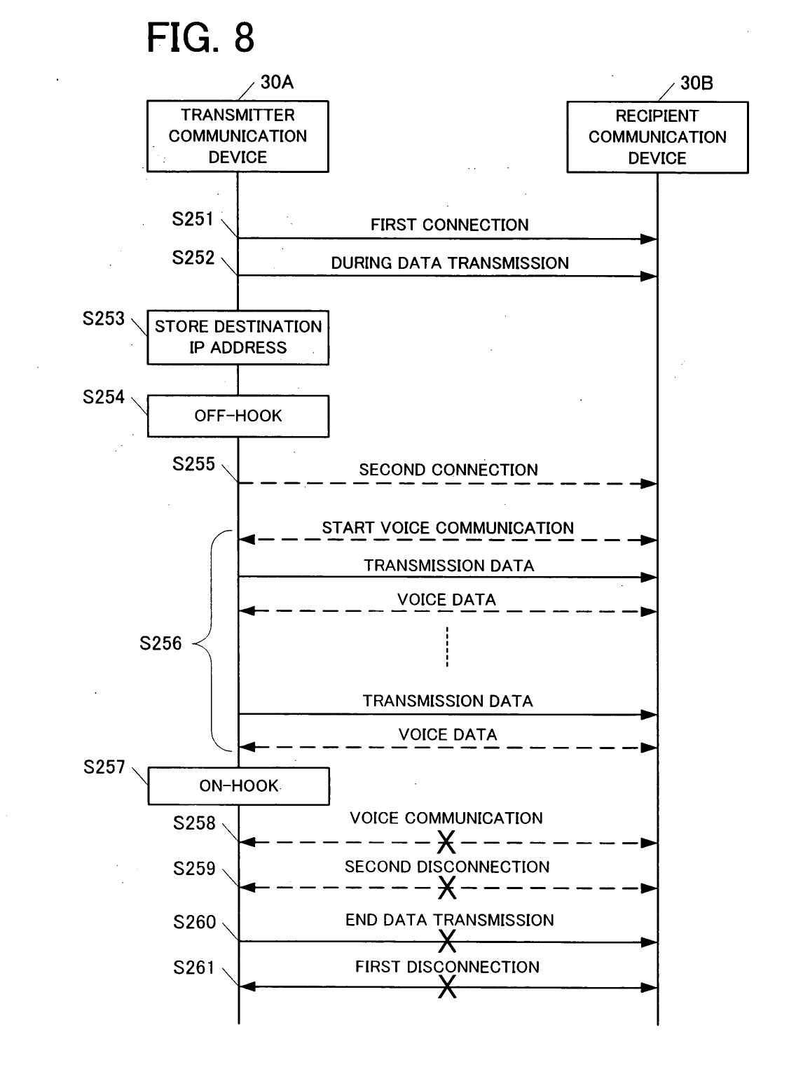

Next, referring to the sequence diagram of FIG. 8, a description will be made to a communication protocol established between the communication devices 30A and 30B when an IP telephone call is made from the transmitter communication device 30A to the recipient communication device 30B while the data communication is being carried out between the communication devices 30.

In one of the communication devices (transmitter communication device) 30A, when an original document is set at the scanning unit 8 by the operator and destination information (mail address, URL, etc.) of the destination (recipient communication device) 30B is input and designated and the start key 11a is pressed, a first connection is established with the destination by the call control (S251). Then, the data communication is established between the communication devices 30A and 30B (S252). The transmitter communication device 30A stores the IP address of the destination acquired from the server or the like in the destination IP address storage unit 29. If an IP address is already stored, the transmitter communication device 30A deletes the stored IP address (S253).

During the data communication, when the transmitter communication device 30A accepts a starting request for starting new voice communication by a specific communication starting operation of the operator (S254), the transmitter communication device 30A assumes that the destination that is carrying out the data communication is the same as a transmission destination to which the voice communication will be carried out newly. Here, the specific communication starting operation differs from a communication starting operation accompanying an input operation of the telephone number of the destination carried out when communication is not being carried out. That is, the specific communication starting operation does not accompany the input operation of the telephone number of the destination. Then, in accordance with the table T, a determination is made as to whether or not the destination that is currently carrying out the data transmission can carry out the voice communication (not shown). When the voice communication can be carried out, by using connection information relating to the first connection that is carrying out the IP communication, in other words, by designating the IP address stored in the destination IP address storage unit 29 as the destination of the voice communication, a second connection is established with the same destination (S255). Further, as it is evident from the above description, the second connection is a new connection that is different from the first connection.

Then, at the same time as when the data is transmitted from the transmitter communication device 30A to the recipient communication device 30B on the first connection, the voice communication is carried out on the second connection (S256).

When the telephone conversation with the destination has been completed and the handset 13 has been on-hooked (S257), the generation and the output of the voice data from the transmitting voice data generating unit 26 of the IP telephone communication unit 23 are stopped and the voice communication ends (S258) and the second connection is disconnected (S259). When image data of a last page of the original document is transmitted to the destination, the data transmission also ends (S260) and the established first connection is disconnected (S261). Further, although not shown in the drawing, after the data communication has been ended, when the handset 13 is off-hooked, processes of ending the data transmission, disconnecting the first connection, ending the voice communication and disconnecting the second connection are executed in this order.

A detailed description will not be made to a case in which another data transmission is carried out from the transmitting communication device 30A while the data transmission is being carried out between the communication devices 30 according to the second embodiment of the present invention. However, in this case, each of the data transmissions is carried out on different connections. That is, in the communication protocol established between the communication devices described in the first embodiment, the primary data communication is carried out on the first connection and the secondary data communication is carried out on the second connection. The secondary data communication carried out on the second connection is processed in preference to the primary data communication carried out on the first connection.

As it is evident from the above description, according to the communication device 30 of the second embodiment, effects that are the same as the communication device 1 of the first embodiment can be obtained.

In the above-described first and second embodiments of the present invention, the communication device according to the present invention has been described. However, the data communication in the communication devices 1 and 30 is not limited to the IP facsimile communication and can be other data communication such as a Hyper Text Transfer Protocol (HTTP) communication. Moreover, the instruction operations such as the off-hooking and the on-hooking of the handset 13 and the pressing of the start key are handled as a trigger for starting new communication or ending the communication. However, the instruction operations are not limited to these examples. If the instruction operations are operations that can be carried out easily by the operator, the instruction operations can be replaced with other operations.

In the above-described first and second embodiments, the description has been made with examples of a case in which one data communication is started during one voice communication, and a case in which one voice communication is started during one data communication. However, two or more data communications can also be started during one voice communication, and two or more data communications can also be started during one data communication.

1. An Internet Protocol (IP) communication device comprising:
a communication unit that communicates with another IP communication device via a network;
an accepting unit that accepts a starting request for starting a new IP communication with the other IP communication device while IP communication is being carried out with the other IP communication device; and
an establishing unit that establishes the new IP communication by multiplexing at an upper layer of the network by using a connection that is carrying out the IP communication when accepting the starting request.

2. The IP communication device according to claim 1, wherein the communication that is being carried out during the IP communication is voice communication and the new IP communication is data communication.

3. The IP communication device according to claim 1, wherein the communication that is being carried out during the IP communication is data communication and the new IP communication is voice communication.

4. The IP communication device according to claim 1, wherein the starting request for starting the new IP communication is carried out by a communication starting operation that does not specify a communication destination.

5. The IP communication device according to claim 1, wherein the new IP communication is processed in advance in preference to the IP communication that is being carried out during the communication.

6. An Internet Protocol (IP) communication device comprising:
a communication unit that communicates with another IP communication device via a network;
a storage unit that stores connection information with the other IP communication device;
an accepting unit that accepts a starting request for starting a new IP communication with the other IP communication device while IP communication is being carried out with the other IP communication device; and
an establishing unit that establishes the new IP communication after establishing a new connection different from a connection that is carrying out the IP communication by using the stored connection information when accepting the starting request.

7. The IP communication device according to claim 6, wherein the communication that is being carried out during the IP communication is voice communication and the new IP communication is data communication.

8. The IP communication device according to claim 6, wherein the communication that is being carried out during the IP communication is data communication and the new IP communication is voice communication.

9. The IP communication device according to claim 6, wherein the starting request for starting the new IP communication is carried out by a communication starting operation that does not specify a communication destination.

10. The IP communication device according to claim 6, wherein the new IP communication is processed in advance in preference to the IP communication that is being carried out during the communication.

11. An Internet Protocol (IP) communication device comprising:
means for communicating with another IP communication device via a network;
means for accepting a starting request for starting a new IP communication with the other IP communication device while IP communication is being carried out with the other IP communication device; and
means for executing the new IP communication by multiplexing at an upper layer of the network by using a connection that is carrying out the IP communication when accepting the starting request.

12. An Internet Protocol (IP) communication device comprising:
means for communicating with another IP communication device via a network;
means for storing connection information with the other IP communication device;
means for accepting a starting request for starting a new IP communication with the other IP communication device while IP communication is being carried out with the other IP communication device; and
means for executing the new IP communication after establishing a new connection different from a connection that is carrying out the IP communication by using the stored connection information when accepting the starting request.
